(19) United States
(12) Patent Application Publication
(10) Pub. No.: US 2023/0159229 A1
(43) Pub. Date: May 25, 2023

(54) SYSTEMS FOR MOUNTING A RECEPTACLE

(71) Applicant: David MARKS, Seattle, WA (US)

(72) Inventor: David MARKS, Seattle, WA (US)

(21) Appl. No.: 17/993,101

(22) Filed: Nov. 23, 2022

Related U.S. Application Data
(60) Provisional application No. 63/282,398, filed on Nov. 23, 2021.

(51) Int. Cl. B65D 33/14; B65F 1/00

(52) U.S. Cl. CPC B65D 33/14; B65F 1/0013; B65F 2250/108

(57) ABSTRACT

Devices for mounting receptacles to surfaces are described herein. The device includes a receptacle having a back panel, side panels that extend from the back panel in a direction that is perpendicular to the back panel, a front panel attached to the side panels and generally opposite the back panel, a base portion coupled to and perpendicular to the back panel, the front panel, and the side panels, and a top portion generally opposite the base portion that is open to receive various items. The system further includes an adhesive coupled to the back panel, the adhesive configured to couple the receptacle to a surface. This configuration allows surface dust and debris due to construction to be contained and stored for disposal.

### CROSS-REFERENCE TO RELATED APPLICATIONS

The present application claims priority to and the benefit of U.S. Provisional Patent Application No. 63/282,398, filed Nov. 23, 2021, the contents of which are hereby incorporated in their entirety.

### TECHNICAL FIELD

The present disclosure relates to a system for mounting receptacles to surfaces.

### BACKGROUND

Falling drywall dust and debris are a typical consequence of drilling, cutting, and various construction projects. The result of fallen construction debris may be harmful to an environment and often requires elaborate clean up that may not be environmentally-friendly. Often, furniture or other items may get impacted by construction or drywall dust and debris. There is therefore a need for a device that contains construction debris and improves current construction debris cleanup. There is a further need for the device to prevent harmful environmental impacts from such debris and cleanup processes.

### SUMMARY

The present disclosure is a system that includes a receptacle having a back panel, side panels that extend from the back panel in a direction that is perpendicular to the back panel, a front panel attached to the side panels and generally opposite the back panel, a base portion coupled to and perpendicular to the back panel, the front panel, and the side panels, and a top portion generally opposite the base portion that is open to receive various items. The system further includes an adhesive coupled to the back panel, the adhesive configured to couple the receptacle to a surface.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a schematic plan view of a mounting system according to an embodiment of the present disclosure; and

FIG. 2 is a back perspective view of the mounting system shown in FIG. 1.

### DETAILED DESCRIPTION OF ILLUSTRATIVE EMBODIMENTS

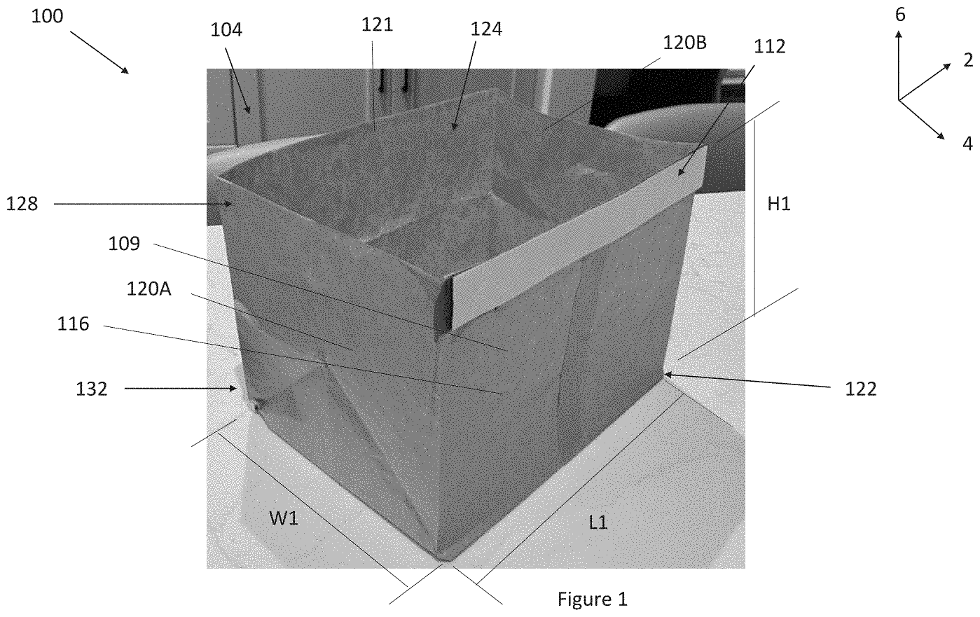

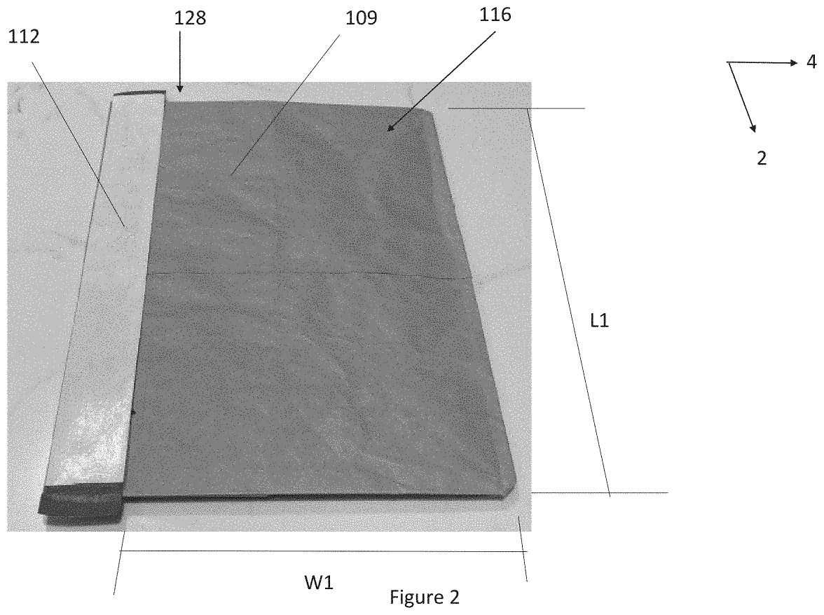

Referring to FIGS. 1-2, embodiments of the present disclosure include a system 100 configured to mount a receptacle 104 to a mounting surface 108 (not depicted) utilizing an adhesive material 112. As described herein, a mounting surface 108 may be any surface to which a receptacle 104 can be affixed, such as a wall, corner, door, etc. In some instances, the mounting surface 108 may a singular flat surface, such as any wall or vertical flat structure. The mounting system 100 may be used to contain and dispose various items during construction. Current processes and methods to gather and contain construction surface dust and debris may leave debris on furniture and floors, requiring further cleaning methods. The system 100 as described herein may be used to address or mitigate the impact of such issues.

Referring to FIGS. 1-2, the receptacle 104 is utilized for containing and storing objects on a mounting surface 108. The receptacle 104 includes a back panel 116, side panels 120A, 120B extending from the back panel 116 in a direction that is perpendicular to the back panel 116, and a front panel 121 attached to the side panels 120A, 120B and generally opposite the back panel 116. The receptacle 104 further includes a base portion or base 122 coupled to and perpendicular to the back panel 116 and an opening 124 generally opposite the base portion 122 that is open to receive various items. The panels 116, 120A, 120B, 121, and base portion 122 may be formed from flexible sheets that are sealed or secured together by heat sealing, ultrasonic sealing, impulse sealing, radio frequency (RF) sealing, or other techniques known in the art.

In the illustrated embodiment, the receptacle 104 comprises paper. In alternative embodiments, the receptacle 104 may be made of various materials including reusable cloth, cardboard, various plastics, acrylic, metal, and silicone. In addition, each panel of the receptacle 104 may be made of different materials. In the illustrated embodiment, the receptacle 104 is a paper bag. In alternative embodiments, the receptacle 104 is a silicone pouch. In the illustrated embodiment, the receptacle 104 is foldable and disposable. The receptacle 104 may be designed so that it may be manufactured, stored, and/or shipped in a flat form.

The side panels 120A, 120B, the back panel 116, the front panel 121, and the base 122 form a top portion 128 and a bottom portion 132 of the system 100. The receptacle 100 has a length L1 that extends along a longitudinal direction 2, a width W1 that extends along a lateral direction 4 that is opposite the longitudinal direction 2, and a height H1 that extends along a transverse direction 6 that is perpendicular to the longitudinal direction 2 and lateral direction 4. In the illustrated embodiment, the length L1 may about 6 inches to about 12 inches, the width W1 may be about 6 inches to about 12 inches, and the height H1 may be about 2 inches to about 6 inches. In alternative embodiments, the dimensions of the receptacle 104 may vary.

In the illustrated embodiment, the receptacle 104 includes side panels 120A, 120B. The side panels 120A, 120B are rectangular in shape. The side panels 120A, 120B extend in a perpendicular direction from the back panel 116. In the illustrated embodiment, the side panels 120A, 120B have substantially identical dimensions. The side panels 120A, 120B extend parallel to each other from the back panel 116 and perpendicular to the front panel 121, the back panel 116, and the base portion 122. In alternative embodiments, the shape and size of the side panels 120 may vary.

Continuing with FIGS. 1-2, in the illustrated embodiment, the front panel 121 is rectangular in shape. In alternative embodiments, the shape of the front panel 121 may vary. The front panel 121 extends parallel to the back panel 116 and perpendicular to the side panels 120A, 120B and the base portion 122.

In the illustrated embodiment, the front panel 121 and the side panels 120A, 120B form the opening 124 at the top portion 128 of the receptacle 104. The opening 124 is configured to allow for objects to be placed and contained inside the receptacle 104. The opening 124 is further configured to allow for debris to be caught inside the receptacle 104.

The back panel 116 may be coupled to the mounting surface 108 via the adhesive material 112. In the illustrated embodiment, the back panel 116 may be rectangular in shape. In alternative embodiments, the shape of the back panel 116 may vary. The back panel 116 may include an outer surface 109 configured to be coupled to the mounting surface 108 and an inner surface 110 opposite the outer surface 109.

The adhesive material 112 is configured to couple the receptacle 104 to the mounting surface 108. The adhesive material 112 is coupled to the outer surface 109 of the back panel 116. In the illustrated embodiment, the adhesive material 112 is coupled to the top portion 128 of the back panel 116. In alternative embodiments, the adhesive material 112 may be attached on any portion or the entirety of the outer surface 109 of the back panel 116. The adhesive material 112 allows the receptacle 104 to be placed on the mounting surface 108 such that the receptacle 104 may be used to contain objects and suspend the objects on the mounting surface 108 or such that the receptacle 104 may be used to catch debris. In the illustrated embodiment, the adhesive material 112 extends along the entire length L1 of the back panel 116. In alternative embodiments, the adhesive material 112 extends along a portion of the length L1 of the back panel 116. The adhesive material 112 may include wet adhesives, contact adhesives, reactive adhesives, single-component reactive adhesives, two-component reactive adhesives, hot-melt adhesives, and/or pressure-sensitive adhesives.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in an order as desired.

1. A system, comprising:
a receptacle configured to contain items or debris on a wall surface, the receptacle having a back panel, side panels that extend from the back panel in a direction that is perpendicular to the back panel, a front panel attached to the side panels and generally opposite the back panel, a base portion coupled to and perpendicular to the back panel, the front panel, and the side panels, and an opening generally opposite the base portion; and
an adhesive coupled to the back panel, the adhesive configured to mount the receptacle to a wall surface.

2. The system of claim 1, wherein the receptacle comprises paper.

3. The system of claim 2, wherein the receptacle is a paper bag.

4. The system of claim 1, wherein the receptacle comprises silicone.

5. The system of claim 4, wherein the receptacle is a silicone pouch.

6. The system of claim 1, wherein the receptacle is foldable.

7. The system of claim 1, wherein the receptacle is disposable.

8. The system of claim 1, wherein the receptacle is configured to store and contain various objects, tools, or debris from construction.

9. The system of claim 1, wherein the wall surface is a vertical wall.

10. The system of claim 1, wherein the adhesive extends along a length of the back panel.

11. The system of claim 1, wherein the adhesive is coupled to a top portion of the back panel.

12. The system of claim 1, wherein the adhesive is a wet adhesive.

13. The system of claim 1, wherein the adhesive is a contact adhesive.

14. The system of claim 1, wherein the receptacle is manufactured, stored, or shipped in a flat form.

15. The system of claim 1, wherein the back panel, side panels, front panel, and base portion is formed from flexible sheets that are sealed or secured together.

16. The system of claim 15, wherein the flexible sheets are sealed together via heat sealing.

17. The system of claim 15, wherein the flexible sheets are sealed together via ultrasonic sealing.

18. The system of claim 1, wherein the receptacle has a length of about 6 inches to about 12 inches.

19. The system of claim 1, wherein the receptacle has a width of about 6 inches to about 12 inches.

20. The system of claim 1, wherein the receptacle has a height of about 2 inches to about 6 inches.
